(19) United States
(12) Patent Application Publication
(10) Pub. No.: US 2026/0145923 A1
(43) Pub. Date: May 28, 2026

(54) Container Treatment System With Component Receptacle

(71) Applicant: KRONES AG, Neutraubling (DE)

(72) Inventor: Franz BRAUN, Neutraubling (DE)

(21) Appl. No.: 19/400,887

(22) Filed: Nov. 25, 2025

(30) Foreign Application Priority Data
Nov. 26, 2024 (DE) 10 2024 134 742.2

(51) Int. Cl. B67C 3/00; B67C 7/00

(52) U.S. Cl. CPC B67C 3/007; B67C 7/00

(57) ABSTRACT

A container treatment apparatus for treating containers, for example for filling containers with a filling product and/or for closing containers filled with a filling product with a container closure, includes a housing part delimiting a treatment chamber and an electrical and/or electronic component for monitoring and/or illuminating a treatment module in the treatment chamber, wherein the electrical and/or electronic component is arranged in a component receptacle that projects through the housing part into the treatment chamber.

### CROSS-REFERENCE TO RELATED APPLICATIONS

This application claims priority from German Patent Application No. DE 102024134 742.2, filed on November 26, 2024 in the German Patent and Trademark Office, the disclosure of which is incorporated herein by reference in its entirety.

### BACKGROUND

### Technical Field

The present invention relates to a container treatment apparatus for treating containers, for example for filling containers with a filling product and/or for closing containers filled with a filling product with a container closure.

### Related Art

Container treatment systems are known in which containers to be filled are first produced in a stretch blow molding module by means of a stretch blow molding process, are then filled with the respective filling product by means of a filler and are then closed by means of a closer. The corresponding modules of the container treatment system, i.e. for example the stretch blow molding module, the filler or the closer, are typically enclosed in a housing. The housing protects operators from an intervention in components of the modules moving at high speed and from filling product thrown out for example in the case of a defective container. At the same time, the housing can protect the penetration of undesired objects and particles into the filling product.

For particularly sensitive products, it is known to arrange the modules, in particular the filler and the closer, in a so-called isolator which provides a space completely closed off from the surroundings. In this way, it can be ensured that the filling product comes into contact only with a defined atmosphere present within the isolator.

Such an isolator can be designed for example such that it is substantially hermetically closed off from the surroundings. The introduction of containers to be filled and the discharge of finally filled containers is achieved by means of corresponding locks which ensure that a defined atmosphere is present in the interior of the isolator even during operation.

Aseptic isolators are used in the field of particularly sensitive filling products, wherein a particularly germ-free atmosphere or a protective gas atmosphere is provided here within the isolator. For example, milk products can preferably be filled in such an aseptic isolator.

The use of an isolator is furthermore important in order to protect an operator and the surroundings from contact with cleaning media such as, for example, lye or hot water when an automated cleaning of the device with cleaning media is carried out.

If treatment modules of the container treatment apparatus are arranged in such an isolator, a direct view from the outside or a monitoring from the outside is made more difficult on account of the sealing isolator walls. An operator can also not simply intervene in the treatment chamber or select a preferred observation position within the treatment chamber in order, for example, to carry out adjustment work on components of the treatment modules.

### SUMMARY

A container treatment apparatus which permits more reliable monitoring of an interior of an isolator is described herein according to various embodiments.

Correspondingly, a container treatment apparatus for treating containers, for example for filling containers with a filling product and/or for closing containers filled with a filling product with a container closure, is proposed, which comprises a housing part delimiting a treatment chamber. Furthermore, an electrical and/or electronic component is provided for monitoring and/or illuminating a treatment module in the treatment chamber.

Correspondingly, monitoring or adjustment of machine components of a treatment module can be carried out by means of the electrical and/or electronic components.

According to the invention, the electrical and/or electronic component is arranged in a component receptacle that projects through the housing part into the treatment chamber and seals the treatment chamber.

As a result, it can be achieved that the electrical and/or electronic component can indeed act within the treatment chamber but is actually located outside the treatment chamber with respect to the separation of the chambers. In particular, it is thereby possible to leave a treatment chamber formed as an isolator chamber undamaged and to achieve a separation between the outer region, in which the electrical and/or electronic component is arranged, and the treatment chamber.

The component receptacle in some embodiments comprises a transparent delimitation which defines a receiving volume for receiving the electrical and/or electronic component and which projects into the treatment chamber to such an extent that a line of sight is formed between the electrical and/or electronic component and the treatment module.

As a result of the transparent delimitation, the electrical and/or electronic component can interact optically with the treatment chamber, in one embodiment the isolator chamber, without the electrical and/or electronic component actually being located within this chamber. The electrical and/or electronic component here actually acts from the outside into the treatment chamber, but can nevertheless produce a line of sight, so that optical monitoring or illumination of the treatment module to be monitored is possible.

The transparent delimitation can be designed in the form of a cylinder, a cone, a truncated cone, or a hemispherical dome. In this way, entry into the treatment chamber is particularly readily possible and a line of sight can be produced with the modules to be monitored.

In order to be able to withstand the harsh conditions in a treatment chamber and to achieve durability, the transparent delimitation is in several embodiments formed from a transparent, alkali-resistant, acid-resistant, and temperature-resistant material and particularly in certain embodiments comprises acrylic glass, glass, or plexiglass.

The transparent delimitation is in one or more embodiments received in a sealing manner with respect to the housing part. Particularly in various embodiments, the transparent delimitation is elastically held with respect to the housing part and in some embodiments also sealed in particular by means of a first elastic element and/or a second elastic element which receive between them a flange region of the transparent delimitation.

The transparent delimitation can be sealed to the housing part via a hygienic sealing ring such that, from the perspective of the treatment chamber, undercuts and non-flushable regions are avoided. In this way, a particularly hygienic design can be achieved which can also be used for use in a clean room or an aseptic isolator.

The treatment chamber can be an isolator chamber and the delimiting housing part can be a wall, in one embodiment a top plate, of a housing delimiting the isolator chamber.

In order to achieve monitoring or illumination of the treatment module of interest in the treatment chamber, the electrical and/or electronic component can be a lamp, a light, a camera and/or a smartphone.

An exemplary assembly and maintenance can be achieved if the component receptacle is formed as a preassembled assembly.

### BRIEF DESCRIPTION OF THE FIGURES

Further embodiments of the invention are explained in more detail by the following description of the figures.

FIG. 1 shows a schematic perspective sectional view of a portion of a container treatment apparatus having a component receptacle in which an electrical or electronic component can be received,

FIG. 2 shows a schematic lateral sectional view of the portion of the container treatment apparatus from FIG. 1,

FIG. 3 shows a schematic perspective sectional view of the portion of the container treatment apparatus from FIGS. 1 and 2, wherein a light is now arranged as an electrical component in the component receptacle,

FIG. 4 shows a schematic lateral sectional view of the portion of the container treatment apparatus from FIG. 3,

FIG. 5 shows a schematic perspective illustration of an upper part, illustrated by way of example, of a capper having a plurality of installed component receptacles, and

FIG. 6 shows a schematic side view of the upper part, illustrated by way of example, of the capper from FIG. 5 having installed component receptacles.

### DETAILED DESCRIPTION

Exemplary embodiments are described below with reference to the figures. In this case, identical, similar or identically acting elements are provided with identical reference signs in the different figures, and repeated description of these elements is partially dispensed with in order to avoid redundancies.

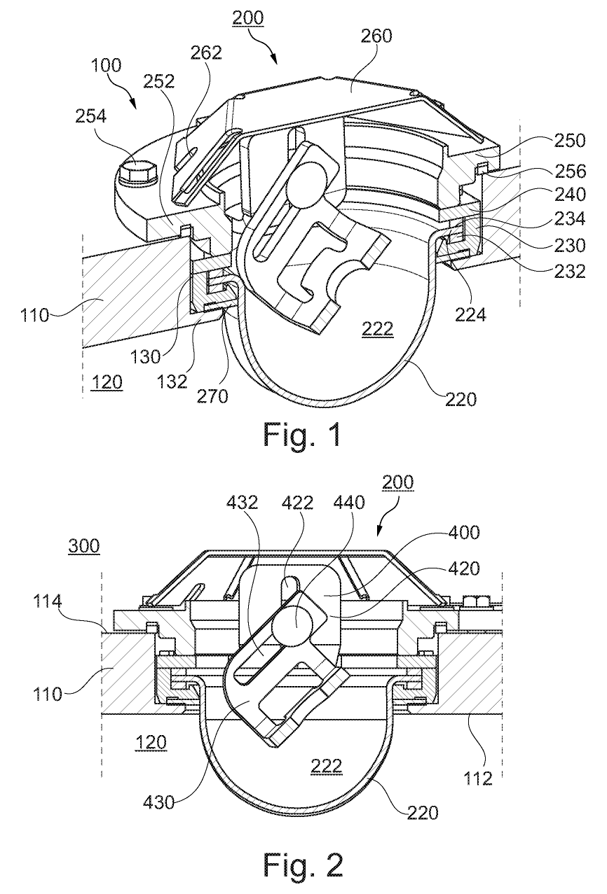

FIG. 1 shows a detail of a container treatment apparatus 100, wherein a section through a top plate 110 of an isolator (not illustrated further) is shown schematically here. In this case, the top plate 110 closes off an isolator chamber 120, indicated schematically by means of the reference sign 120, at the top. The isolator chamber 120 is usually also delimited off from the surroundings 300 by further other walls.

A receptacle opening 130, in which a component receptacle 200 is inserted, is provided in the top plate 110. The component receptacle 200 is provided to receive an electrical and/or electronic component such as, for example, a light, a camera, a sensor, a smartphone, etc., such that the electrical component can be used for optical interaction, in particular for optical monitoring or for illumination of the isolator chamber 120.

For this purpose, the component receptacle 200 comprised a transparent delimitation 220 which projects into the isolator chamber 120 in the installed state and provides a receiving volume 222. At least a partial region of the electrical and/or electronic component can be received in the receiving volume 222.

In the exemplary embodiment shown in FIG. 1, the transparent delimitation 220 is designed in the form of a hemispherical dome which is produced from a transparent material such as, for example, plexiglass. The delimitation 220 can also be formed from glass or acrylic glass.

In this way, the transparent material of the delimitation 220 allows optical access of the electrical and/or components received in the receiving volume 222, such as, for example, a light or a camera or a smartphone, from the surroundings 300 into the isolator chamber 120. In other words, for example, a lamp received in the receiving volume 222 can radiate into the isolator chamber 120 through the wall provided by the transparent delimitation 220.

As shown in FIGS. 1 and 2, the transparent delimitation 220 can be designed in the form of a hemispherical dome. However, other geometric shapes are likewise conceivable, such as, for example, the design of the transparent delimitation 220 in the form of a cylinder, cone, truncated cone, or other geometric shapes which extend into the isolator chamber 120 and which can project into the isolator chamber 120, and at the same time be able to receive the corresponding electrical components in a receiving volume 222 on the side of the delimitation 220 facing away from the isolator chamber 120.

FIG. 1 is a perspective sectional illustration of the component receptacle 200, whereas FIG. 2 is a sectional illustration directly from the side.

In the illustration of FIG. 2, the shape of the transparent delimitation 220 can be seen once again particularly well. At least in its downwardly pointing portion in FIG. 2, the delimitation 220 is designed substantially like a hemispherical dome.

On its lower side 112, the top plate 110 forms a termination plane which closes off the isolator chamber 120 at the top. The transparent delimitation 220 projects beyond the termination plane defined by the lower side 112 of the top plate 110. As a result, part of the receiving volume 222 is located within the isolator chamber 120 but is at the same time completely separated from the isolator chamber 120 in a hygienic manner by the transparent delimitation 220.

In other words, the transparent delimitation 220 allows the surroundings 300 lying by definition outside the isolator chamber 120 to be drawn into the isolator chamber 120 virtually in such a way that an electrical component arranged in the surroundings 300 nevertheless has optical access to the isolator chamber 120.

Due to the transparent delimitation 220 projecting into the isolator chamber 120, it is thus possible for electrical components to be introduced which can carry out monitoring of the isolator chamber 120 and in particular of the modules of a container treatment apparatus 100 provided therein, for example a closer, a filler or a stretch blow molding apparatus. At the same time, the volume of the isolator chamber 120 remains undamaged and the hermetic delimitation from the surroundings 300 remains so that an aseptic design is also possible.

The component receptacle 200 and in particular the transparent delimitation 220 project into the isolator chamber 120 to be monitored but separated from the surroundings 300 in such a way that a direct optical connection can be produced between the electrical components received in the receiving volume 222 of the delimitation 220 of the component receptacle 200 and the modules to be monitored received in the isolator chamber 120. In other words, a direct line of sight can be produced between the receiving volume 222 and the module to be monitored.

The geometric dimensioning of the delimitation 220 therefore results both from the positioning of the modules of the container treatment apparatus 100 to be monitored in the isolator chamber 120 and from the physical extent of the electrical components to be received in the receiving volume 222. The larger the electrical components which are to be received in the receiving volume 222 projecting into the isolator chamber 120, the larger the transparent delimitation 220 has to be dimensioned.

It likewise depends on the point within the isolator chamber 120 at which the respective module to be monitored of the container treatment apparatus 100 is arranged relative to the component receptacle 200. If, for example, the module to be monitored is provided directly below the component receptacle 200, with the result that an optical connection can be produced between the component receptacle 200 and the module to be monitored in the isolator chamber 120 in such a way that this optical connection extends virtually perpendicularly to the plane formed by the lower side 112 of the top plate 110, the requirements for the delimitation 220 to project into the isolator chamber 120 are only low.

However, if the module to be monitored lies substantially in or on the plane formed by the lower side 112 of the top plate 110, the transparent delimitation 220 has to extend very far into the isolator chamber 120 in order to be able to correspondingly produce an optical connection between the module to be monitored of the container treatment apparatus 100 and the electrical component received in the receiving volume 222.

However, the transparent delimitation 220 always extends into the space to be monitored, that is to say into the isolator chamber 120 in the exemplary embodiment shown. In this case, the isolator chamber 120 is defined by the housing walls delimiting the isolator chamber 120, by way of example by the top plate 110 shown in FIGS. 1 and 2. These respective outer delimitations of the isolator chamber 120 are defined by corresponding housing parts which each form a plane.

The fact that the transparent delimitation 220 extends into the isolator chamber 120 is understood to mean that the transparent delimitation 220 extends beyond a plane defined by the housing parts of the isolator into the space to be monitored of the container treatment apparatus 100.

The component receptacle 200 comprises, in addition to the delimitation 220, further components which will be discussed below.

The component receptacle 200 comprises a mounting body 230 which is inserted into the receptacle opening 130 in the top plate 110. The mounting body 230 receives a first elastic element 232 which is in contact with a flange region 224 of the delimitation 220. The first elastic element 232 is designed as an elastic ring which rests in a ring receptacle of the mounting body 230. A second elastic element 234 is received above the flange region 224, with the result that the flange region 224 of the transparent delimitation 220 is in contact at its underside with the first elastic element 232 and at its upper side with the second elastic element 234.

The elastic elements 232, 234 can in various embodiments be formed from a silicone foam in order to be correspondingly temperature-resistant, acid-resistant, alkali-resistant and durable.

The first elastic element 232 and/or the second elastic element 234 can also be designed as seals, in particular as sealing rings, and seal the flange region 224 of the transparent delimitation 220.

A holding ring 240 makes it possible to press the first elastic element 232 and the second elastic element 234 with the interposed flange region 224 of the transparent delimitation 220 with respect to the mounting body 230. Correspondingly, the delimitation 220 can be held in a hermetically sealed manner between the mounting body 230 and the holding ring 240.

A hygienic seal of the transparent delimitation 220 with respect to the top plate 110 is achieved by an additional hygienic sealing ring 270, wherein the hygienic sealing ring 270 is pressed between the mounting body 230 and a receptacle flange 132 of the top plate 110.

By pressing the elastic elements 232 and 234, a pressing of the hygienic sealing ring 270 is also achieved at the same time.

The hygienic sealing ring 270 prevents the formation of undercuts and non-flushable regions during the connection of the component receptacle 200 to the top plate 110. The hygienic sealing ring 270 allows a smooth and undercut-free sealing of the transparent delimitation 220 with respect to the isolator chamber 120 and at the same time an equally smooth and undercut-free connection to the top plate 110, in particular in the region of the receptacle flange 132 of the receptacle opening 130.

In this way, a particularly hygienic design of the component receptacle 200 is made possible so that the component receptacle 200 can be used without problems in hygienically demanding applications, such as, for example, an aseptic isolator in a container treatment apparatus 100.

The hygienic sealing ring 270 can in several embodiments be a silicone disk in which a recess is provided which allows a sealing reception of the transparent delimitation 220.

In other words, the receptacle opening 130 in the top plate 110 is again closed hygienically from the point of view of the isolator chamber 120 by the combination of the transparent delimitation 220 and the hygienic sealing ring 270.

The holding ring 240 is connected to the mounting body 230. In the present case, the holding ring 240 and the mounting body 240 are screwed together.

The mounting ring 250 serves to screw the component receptacle 200 to the top plate 110 and correspondingly has a flange 252 which has corresponding bolt receptacles and can then be screwed to the top plate 110 by means of screw bolts 254.

By screwing the mounting ring 250 to the top plate 110, the component receptacle 200 is pressed in the direction of the receptacle flange 132 in the receptacle opening 130 of the top plate 110, as a result of which the hygienic sealing ring 270 is then pressed between the mounting body 230 and the receptacle flange 132.

A sealing of the mounting ring 250 with respect to an upper side 114 of the top plate 110 is achieved via a sealing ring 256 which is arranged between the flange 252 of the mounting ring 250 and the upper side 114 of the top plate 110.

Furthermore, an upper cover 260 is provided which delimits the receiving volume 222 of the transparent delimitation 220 at the top, wherein this does not mean sealing or hermetically closing off the receiving volume 222, but merely a mechanical cover which is intended to prevent the electrical components received in the receiving volume 222 from being mechanically accessible from the surroundings 300. The upper cover 260 can have ventilation openings 262 which produce a connection between the receiving volume 222 and the surroundings 300, with the result that an exchange of air can take place.

Correspondingly, the transparent delimitation 220 is that part at which the separation between the isolator chamber 120 to be observed and the surroundings 300 actually takes place.

Since the delimitation 220 is transparent, in particular optically transparent in the visible range, optical observation of the isolator chamber 120 from the surroundings 300 can be made possible. However, the hermetic delimitation of the volume of the isolator chamber 120 is not damaged as a result.

At the same time, the electrical components received in the receiving volume 222 are protected against actions carried out in the isolator chamber 120, such as, for example, cleaning or sterilization or mechanical operations within the isolator chamber 120.

In other words, the electrical components which are received in the receiving volume 222 of the component receptacle 200 do not have to be specifically designed to withstand a cleaning cycle or a sterilization cycle within a container treatment apparatus 100. Correspondingly, specific sealing and design of the electrical components, for example of a camera or a lamp, which are received in the receiving volume 222, is not necessary so that in this way optically particularly high-quality components can be used and/or costs can be saved.

An electrical component can be received on a component holder 400 within the receiving volume 222. In the exemplary embodiment shown, the component holder 400 comprises an L-shaped holder 420 which is formed in one piece with the holding ring 240. The L-shaped holder 420 extends radially inwards into the receiving volume 222 with respect to the holding ring 240 and then upwards.

The L-shaped holder 420 comprises a plate with an elongated hole 422 in which a pivotable holding apparatus 430 is arranged. The pivotable holding apparatus 430 likewise has an elongated hole 432 so that reliable but simultaneously very flexible positioning of an electrical component arranged on the holding apparatus 430 is made possible by means of a holding bolt 440 which engages both in the elongated hole 432 of the pivotable holding apparatus 430 and in the elongated hole 422 of the L-shaped holder 420.

Correspondingly, positioning both in the pivoting direction and in the height direction can be achieved by means of the two elongated holes 422, 432. In the rotation direction, the component receptacle 200 can be rotated such that alignment of an electrical component arranged on the holding apparatus 430 is possible in all degrees of freedom such that the electrical component can be aligned within the receiving volume 222 such that monitoring of the respective module to be monitored in the isolator chamber 120 is flexibly possible.

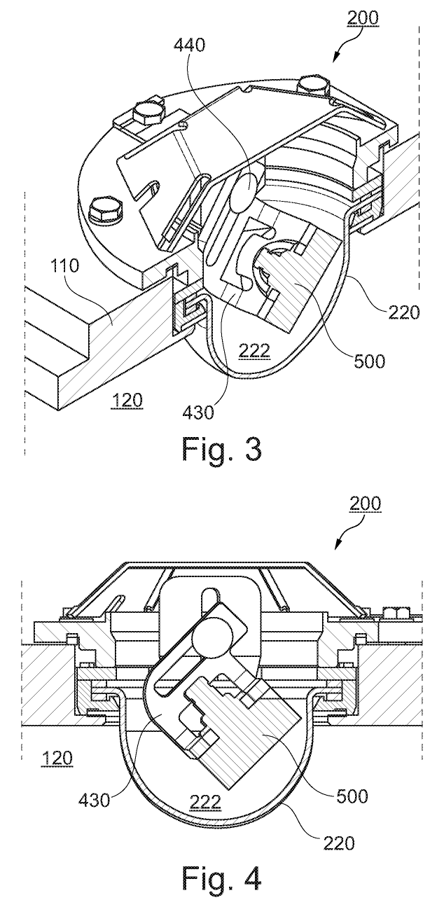

FIGS. 3 and 4 show the component receptacle 200 from FIGS. 1 and 2 in an exemplary design in which an electrical component 500, which is illustrated here by way of example in the form of a lamp or light, is received by way of example on the holding apparatus 430. The light is held on the holding apparatus 430 such that, on account of the degrees of freedom of the holding apparatus, corresponding positioning and alignment of the electrical component 500 within the receiving volume 222 can be achieved such that the illumination of a region within the isolator chamber 120 can be reliably achieved. In particular, a desired region within the isolator chamber 120 can be completely illuminated.

At the same time, the electrical component 500, that is to say the light here, is protected from cleaning media and mechanical loads from the isolator chamber 120, with the result that the electrical component 500 can be selected such that it has the desired optical properties but at the same time does not require specific seals or specifications which make it particularly hygienic or resistant to media used in the isolator chamber 120.

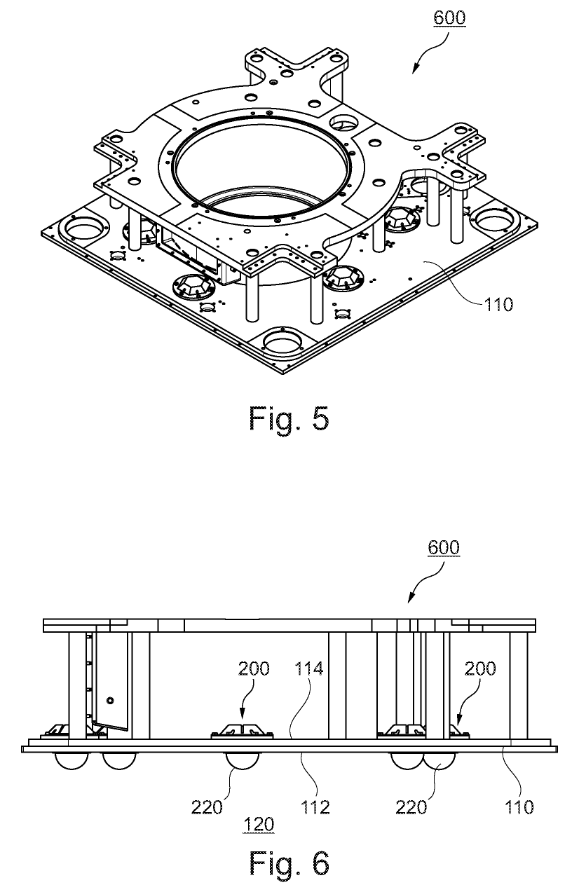

FIGS. 5 and 6 schematically provide the upper side of a housing 600 of a capper. The upper side of the housing 600 has, inter alia, a top plate 110 which forms the upper side of an isolator. FIG. 5 correspondingly shows a schematic perspective illustration and FIG. 6 shows a side view. In the side view of FIG. 6 of the housing 600, it can be seen that the top plate 110 in turn has a lower side 112 and an upper side 114, wherein the lower side 112 correspondingly again forms a delimitation of an isolator chamber 120 (not shown here) but lying below the top plate 110 in the installed state.

A plurality of component receptacles 200 are provided, wherein the respective transparent delimitations 220 of the respective component receptacles 200 projecting into the isolator chamber 120 can be seen in the side view of FIG. 6.

Since the transparent delimitations 220 of the component receptacles 200 project into the isolator chamber 120, electrical components received in the respectively formed receiving volume 222 can correspondingly make optical contact with the isolator chamber 120. For example, a camera provided in one of the component receptacles 200, which camera is received in a receiving volume 222 of the respective transparent delimitation 220, can look into the isolator chamber 120 so that monitoring of modules received in the isolator chamber 120 is made possible. Furthermore, a light received in one of the component receptacles 200 can likewise illuminate the isolator chamber 120 in a targeted manner and in particular aim a light focus or a light cone at a specific module in the isolator chamber 120.

The material which is used for the transparent delimitation 220 is in certain embodiments transparent in the visible range so that here an optical camera or a light can interact in the visible range with modules in the isolator chamber 120.

However, the material which is used for the transparent delimitation 120 can also be transparent in other regions of the electromagnetic spectrum, for example if a thermal imaging camera is used instead of a camera operating in the visible range. Correspondingly, the material of the transparent delimitation 220 must then be designed such that the heat rays of interest to be received by the thermal imaging camera can reach the corresponding camera through the material of the transparent delimitation 220.

The material of the transparent delimitation 220 is furthermore in certain embodiments designed such that it undergoes no discoloration and/or no turbidity even when frequently subjected to aggressive cleaning media such as are used in container treatment apparatuses for cleaning and sterilization. The material is correspondingly in some embodiments transparent, alkali-resistant, acid-resistant, temperature-resistant so that a normal operation of a container treatment apparatus 100 has no negative influence on the optical properties of the component receptacle 200. Exemplary materials for this purpose are acrylic glass, glass, or plexiglass. However, other materials which have the stated properties are likewise suitable.

The container treatment apparatus 100 can be for example a closer, for example a can closer in a can filling system. In such a can closer, it is important to monitor the closing process and to adjust individual machine components accurately in order to achieve reliable closing.

For this purpose, the component receptacle 200 is formed such that it extends into the space to be monitored—in the present case into the isolator chamber 120 —but is hygienically separated from this space to be monitored.

The component receptacle 200 correspondingly extends into the space 120 to be monitored. Reliable monitoring of the machine components of the can closer is thus possible without the electrical components received in the component receptacle 200 having to be protected specifically against aggressive cleaning media.

The component receptacle 200 can be provided as a preassembled assembly so that it merely has to be inserted into a receptacle opening 130 of a top plate 110, has to be screwed to the top plate 110 and then has to make electrical contact. Correspondingly, the component receptacle 200 can also be easily replaced if either the electrical component is defective or it is to be replaced by another. For example, a component receptacle 200 in which a lamp or light is provided can be easily replaced by a component receptacle 200 in which a camera is received.

To the extent applicable, all individual features which are illustrated in the exemplary embodiments can be combined with one another and/or replaced without departing from the scope of the invention.

What is claimed is:

1. A container treatment apparatus for treating containers, comprising:
a housing part delimiting a treatment chamber; and
an electrical and/or electronic component configured to monitor and/or illuminate a treatment module in the treatment chamber,
wherein the electrical and/or electronic component is arranged in a component receptacle that projects through the housing part into the treatment chamber and seals the treatment chamber.

2. The container treatment apparatus of claim 1, wherein the component receptacle comprises a transparent delimitation which defines a receiving volume configured to receive the electrical and/or electronic component and which projects into the treatment chamber to such an extent that a line of sight is formed between the electrical and/or electronic component and the treatment module.

3. The container treatment apparatus of claim 2, wherein the transparent delimitation is in the form of a cylinder, a cone, a truncated cone, or a hemispherical dome.

4. The container treatment apparatus of claim 2, wherein the transparent delimitation comprises a transparent, alkali-resistant, acid-resistant, and temperature-resistant material.

5. The container treatment apparatus of claim 4, wherein the transparent, alkali-resistant, acid-resistant, and temperature-resistant material comprises acrylic glass, glass, or plexiglass.

6. The container treatment apparatus of claim 2, wherein the transparent delimitation is sealed with respect to the housing part by means of a first elastic element and/or a second elastic element that receive between them a flange region of the transparent delimitation.

7. The container treatment apparatus of claim 6, wherein the transparent delimitation is sealed to the housing part via a sealing ring.

8. The container treatment apparatus of claim 1, wherein the treatment chamber comprises an isolator chamber and the housing part comprises a wall of a housing delimiting the isolator chamber.

9. The container treatment apparatus of claim 8, wherein the wall comprises a top plate of the housing delimiting the isolator chamber.

10. The container treatment apparatus of claim 1, wherein the electrical and/or electronic component comprises a lamp, a light, a camera and/or smartphone.

11. The container treatment apparatus of claim 1, wherein the component receptacle comprises a preassembled assembly.

12. An apparatus for filling containers with a filling product or for closing containers filled with a filling product with a container closure, comprising:
a housing part delimiting a treatment chamber; and
an electrical and/or electronic component configured to monitor and/or illuminate a treatment module in the treatment chamber,
wherein:
the electrical and/or electronic component is arranged in a component receptacle that projects through the housing part into the treatment chamber and seals the treatment chamber, and
the component receptacle comprises (1) a transparent delimitation that projects into the treatment chamber and provides a receiving volume configured to receive the electrical and/or electronic component and (2) a pivotable holding apparatus configured to hold the electrical and/or electronic component.

13. The apparatus of claim 12, wherein the transparent delimitation is in the form of a cylinder, a cone, a truncated cone, or a hemispherical dome.

14. The apparatus of claim 12, wherein the transparent delimitation comprises acrylic glass, glass, or plexiglass.

15. The apparatus of claim 12, wherein the transparent delimitation is sealed with respect to the housing part by means of a first elastic element and/or a second elastic element that receive between them a flange region of the transparent delimitation.

16. The apparatus of claim 12, wherein the transparent delimitation is sealed to the housing part via a sealing ring.

17. The apparatus of claim 12, wherein the treatment chamber comprises an isolator chamber and the housing part comprises a wall of a housing delimiting the isolator chamber.

18. The apparatus of claim 17, wherein the wall comprises a top plate of the housing delimiting the isolator chamber.

19. The apparatus of claim 12, wherein the electrical and/or electronic component comprises a lamp, a light, a camera and/or smartphone.

20. The apparatus of claim 12, wherein the component receptacle comprises a preassembled assembly.
